(19) United States
(12) Patent Application Publication
(10) Pub. No.: US 2026/0316667 A1
(43) Pub. Date: Oct. 15, 2026

(54) DIRECTIONAL EMERGENCY VEHICLE LIGHTING SYSTEM WITH INDEPENDENTLY CONTROLLED WARNING ILLUMINATION

(71) Applicant: Directional Lighting IP Holdings LLC, Las Vegas, NV (US)

(72) Inventor: Mohabat Pal Singh, Maple Valley, WA (US)

(21) Appl. No.: 19/567,447

(22) Filed: Mar. 16, 2026

Related U.S. Application Data
(60) Provisional application No. 63/786,971, filed on Apr. 11, 2025.

(51) Int. Cl. B60Q 1/26; B60Q 1/00; B60Q 1/24; F21S 43/19; F21S 45/50; F21V 23/00

(52) U.S. Cl. CPC B60Q 1/2611; B60Q 1/0005; B60Q 1/0094; B60Q 1/24; B60Q 1/2607; F21S 43/19; F21S 45/50; F21V 23/003

(57) ABSTRACT

An emergency vehicle lighting system includes a housing for mounting to a vehicle and directional illumination modules supported by the housing. Each directional illumination module has a fixed optical output direction relative to the housing. A warning light module is supported by the housing. A controller is electrically coupled to directional illumination modules and to the warning light module. The controller receives input corresponding to a selected illumination direction and selectively energizes a subset of the directional illumination modules to emit light in that direction relative to the vehicle. The controller is further configured to selectively energise the warning light module to emit a warning light output according to a warning pattern independently of energisation of the subset of the directional illumination modules.

### TECHNICAL FIELD

This application claims the benefit of priority to U.S. Provisional Patent Application No. 63/786,971, filed on 04/11/2025, the entire contents of which are hereby incorporated by reference for all purposes.

The present invention relates generally to vehicle lighting systems and, more particularly, to emergency vehicle lighting systems having selectively controllable directional illumination and warning light functionality.

### BACKGROUND

Emergency vehicles rely on exterior lighting systems to provide scene illumination and to communicate the presence and movement of the vehicle to surrounding traffic and pedestrians. Conventional emergency vehicle lighting systems typically include warning lights that emit flashing or strobing light patterns intended to attract attention and improve vehicle visibility. Such systems often mount to a roof, grille, or other exterior location of a vehicle and may form part of an integrated light bar or a collection of separate lighting devices.

In addition to warning lights, emergency vehicles frequently use auxiliary lighting, such as spotlights or floodlights, to illuminate a work area or a target location. Operators commonly activate these auxiliary lights using separate controls, and the auxiliary lights often emit light in a fixed forward direction or require mechanical movement to change an illumination direction. These arrangements can increase operator workload and can distract the operator during critical situations.

Some existing lighting systems attempt to address directional illumination by using adjustable spotlights, rotating lamps, or mechanically steerable light heads. Other systems provide multiple fixed light heads arranged around a vehicle and energize all of the light heads simultaneously. While these approaches can provide illumination in more than one direction, they often lack the ability to quickly and selectively illuminate a specific direction without energizing unnecessary lights. Mechanical adjustment mechanisms also introduce complexity, wear, and reliability concerns, particularly in harsh vehicle environments.

Certain lighting systems combine directional lighting with warning light functionality within a single housing. However, these systems commonly tie the operation of directional illumination to warning light operation or limit the available lighting patterns to predefined modes. As a result, operators may be unable to independently control directional illumination and warning light output, reducing flexibility during roadside incidents, search operations, or traffic control scenarios.

Other approaches rely on large integrated light bars that require replacement of existing vehicle equipment or extensive vehicle modification. Such systems can increase cost and installation complexity and may not accommodate retrofitting onto existing vehicles or third party light bars. Additionally, many existing systems provide limited expandability and lack support for programmable control, multi zone illumination, or future software based enhancements.

One example of relevant prior art is U.S. Pub. No. US20120056757A1, titled “Emergency vehicle traffic directional lights.” This reference discloses a removable vehicle directional light unit configured for use on an emergency vehicle for directing traffic. The unit includes a plurality of flashing lights arranged in the shape of an arrow indicating a traffic direction and a control box with selector switches and flasher units to illuminate certain light groupings in patterns corresponding to a selected direction. The device is installable at various exterior vehicle locations and provides visual cues to approaching traffic to reduce congestion at an incident scene. However, this reference primarily focuses on conveying traffic directional cues using flashing patterns and does not disclose or suggest a system having a plurality of fixed orientation directional illumination modules selectively energized based on directional input to illuminate areas around a vehicle while independently controlling warning light output. The disclosed system also lacks programmable control architecture for independent directional scene illumination and staged warning patterns, leaving a need for improved emergency vehicle lighting functionality.

Another relevant prior patent is U.S. Pat. No. 11, 066, 011, titled “Modular light bar arrangement for emergency vehicles.” This reference discloses a modular light bar having interchangeable lighting modules configured to provide illumination in multiple directions around a vehicle by altering the mechanical arrangement of the modules. While the reference describes modular construction and directional lighting capability, it primarily relies on mechanical interchangeability and does not disclose a controller configured to selectively energize predetermined subsets of fixed orientation directional illumination modules in response to directional input while independently controlling warning light operation. The reference also does not address structural control features such as defined power switching stages, organized user interface groupings, or independent spotlight control.

Accordingly, there exists a need for an emergency vehicle lighting system that provides selective directional illumination using fixed orientation light modules, that allows independent control of directional illumination and warning light operation, and that supports both integrated and modular configurations. A need also exists for a system that reduces operator workload, improves situational awareness, and offers flexibility for future control and communication capabilities without introducing mechanical complexity.

### SUMMARY

It will be understood that this disclosure is not limited to the particular systems, and methodologies described, as there can be multiple possible embodiments of the present disclosure which are not expressly illustrated in the present disclosure. It is also to be understood that the terminology used in the description is to describe the particular versions or embodiments only and is not intended to limit the scope of the present disclosure.

The invention provides an emergency vehicle lighting system that enables selective directional illumination independently of warning light operation. The emergency vehicle lighting system includes a housing configured for mounting to a vehicle. A plurality of directional illumination modules mounts to the housing, and each directional illumination module has a fixed optical output direction relative to the housing. At least one warning light module also mounts to the housing.

A controller electrically couples to the plurality of directional illumination modules and to the at least one warning light module. The controller receives an input corresponding to a selected illumination direction and selectively energizes a subset of the plurality of directional illumination modules to emit light in the selected illumination direction relative to the vehicle. The controller independently energizes the at least one warning light module to emit a warning light output according to a warning pattern, regardless of operation of the subset of the plurality of directional illumination modules.

In an embodiment, the plurality of directional illumination modules orient to provide illumination in a plurality of predefined directions relative to the vehicle, including forward, rearward, lateral, and diagonal directions. The controller selectively energizes one or more subsets of the plurality of directional illumination modules to provide single direction illumination or multi zone illumination.

In another embodiment, the controller is configured to execute a selectable safety illumination mode in which the controller applies asymmetric illumination behavior relative to the vehicle. In the safety illumination mode, the controller may prioritize illumination on an approach side of the vehicle, including illumination of a ground region, door region, or operator region adjacent the vehicle, while reducing illumination intensity in a forward or oncoming-traffic direction to mitigate glare. The controller may maintain rearward warning illumination at a warning-appropriate intensity while independently controlling directional illumination and warning light output. The safety illumination mode may be user-selectable or may be automatically invoked based on stored logic, vehicle state information, or sensor input.

In another embodiment, the emergency vehicle lighting system includes a spotlight module supported by the housing. The controller selectively energises the spotlight module independently of at least one warning light module and independently of the plurality of directional illumination modules. The controller further controls the intensity of the spotlight module.

In yet another embodiment, the emergency vehicle lighting system integrates into a vehicle light bar or forms a modular lighting assembly attachable to an existing vehicle lighting structure. The controller receives inputs from a user interface, from a wired vehicle interface, or from a wireless communication interface. The controller executes stored lighting patterns and selectively energises the plurality of directional illumination modules and at least one warning light module in response to the inputs. The controller executes stored firmware or software logic to implement the directional illumination, warning light, spotlight, safety, and anti-glare behaviors using existing light-emitting components.

These and other features and advantages of the present invention will become apparent from the detailed description below, in light of the accompanying drawings.

### BRIEF DESCRIPTION OF THE DRAWINGS

FIG. 1 illustrates a general implementation environment of an emergency vehicle lighting system mounted to a vehicle and showing selective directional illumination relative to the vehicle, in accordance with an exemplary embodiment of the present invention;

FIG. 2 illustrates a perspective view of the emergency vehicle lighting system showing a housing supporting a plurality of directional illumination modules and at least one warning light module, in accordance with an exemplary embodiment of the present invention;

FIG. 3A illustrates a top view of the emergency vehicle lighting system, according to one embodiment of the present invention;

FIG. 3B illustrates a side view of the emergency vehicle lighting system, according to one embodiment of the present invention;

FIG. 4 illustrates an exemplary directional illumination activation scheme showing selective energization of subsets of the plurality of directional illumination modules to provide illumination in different directions, according to one embodiment of the present invention;

FIG. 5 illustrates a block diagram of an electrical architecture of the emergency vehicle lighting system including a controller, a user interface, and electrical connections to the plurality of directional illumination modules and the at least one warning light module, according to one embodiment of the present invention;

FIG. 6 illustrates an exemplary user interface configured to provide directional selection inputs and warning light control inputs, in accordance with one embodiment of the present invention;

FIG. 7 illustrates a modular lighting assembly configured for attachment to an existing vehicle light bar, according to one embodiment of the present invention;

FIG. 8 illustrates an embodiment including a spotlight module supported by the housing and controlled independently of the plurality of directional illumination modules and the at least one warning light module, according to one embodiment of the present invention;

FIG. 9 illustrates an alternative embodiment in which the controller communicates with an external device through a wired or wireless communication interface, according to one embodiment of the present invention;

FIG. 10 illustrates a detailed structural embodiment of the emergency vehicle lighting system showing exemplary power switching components, power regulation components, user interface groupings, and environmental protection features that provide fallback structural support, according to one embodiment of the present invention; and

FIG. 11 illustrates an example process flow of a method of operating the emergency vehicle lighting system, in accordance with one embodiment of the present invention.

### DETAILED DESCRIPTION

As used in the specification, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. There may be additional components or processes described in the foregoing application that are not depicted on the described drawings. In the event, such a component or process is described, but not depicted in a drawing, the absence of such component and process from the drawings should not be considered as an omission of such design from the specification.

Before describing the present invention in detail, it should be observed that the present invention utilizes a combination of components or processes, which constitutes an emergency vehicle lighting system. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items. Further, the word “user” and “person” are used interchangeably in the description.

As used herein, the terms directional illumination module, illumination zone, illumination region, illumination segment, and logical grouping may refer to physically separate light assemblies, separately addressable portions of a shared light assembly, segmented optical portions, grouped emitters, or other selectively controllable portions of the emergency vehicle lighting system. Accordingly, directional selection and selective energization described herein may be implemented using discrete modules, grouped emitters, segmented optics, pixelated lighting structures, or combinations thereof.

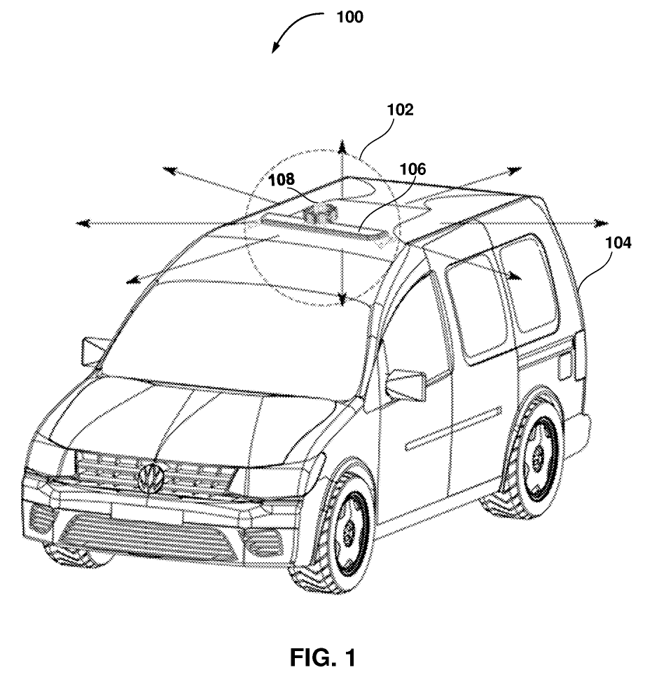

An emergency vehicle lighting system will now be described with reference to the accompanying drawings, particularly FIGS. 1-11.

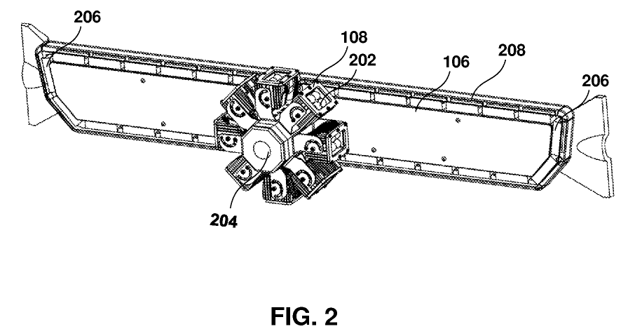

Referring to FIG. 1 in conjunction with FIGS. 2–11 illustrates a general implementation environment 100 of an emergency vehicle lighting system 102 mounted to a vehicle 104. The emergency vehicle lighting system 102 provides selectively controllable directional illumination and warning light functionality relative to the vehicle 104.

The emergency vehicle lighting system 102 includes a housing 106 configured for mounting to the vehicle 104. In the illustrated embodiment, the housing 106 mounts to a roof region of the vehicle 104. In other embodiments, the housing 106 mounts to a grille, bumper, rear deck, roll bar, or another exterior or interior mounting location of the vehicle 104.

The housing 106 supports a plurality of directional illumination modules 108. Each directional illumination module 108 has a fixed optical output direction relative to the housing 106. In the embodiment shown in FIG. 1, the plurality of directional illumination modules 108 orient to provide illumination in multiple predefined directions relative to the vehicle 104, including forward, rearward, lateral, and diagonal directions. The fixed orientation of each directional illumination module 108 eliminates a need for mechanical movement to change an illumination direction.

The housing 106 also supports at least one warning light module (as shown in FIG. 2). The at least one warning light module emits a warning light output configured to increase visibility of the vehicle 104 to surrounding traffic and pedestrians. In some embodiments, the at least one warning light module emits flashing or strobing light according to one or more warning patterns.

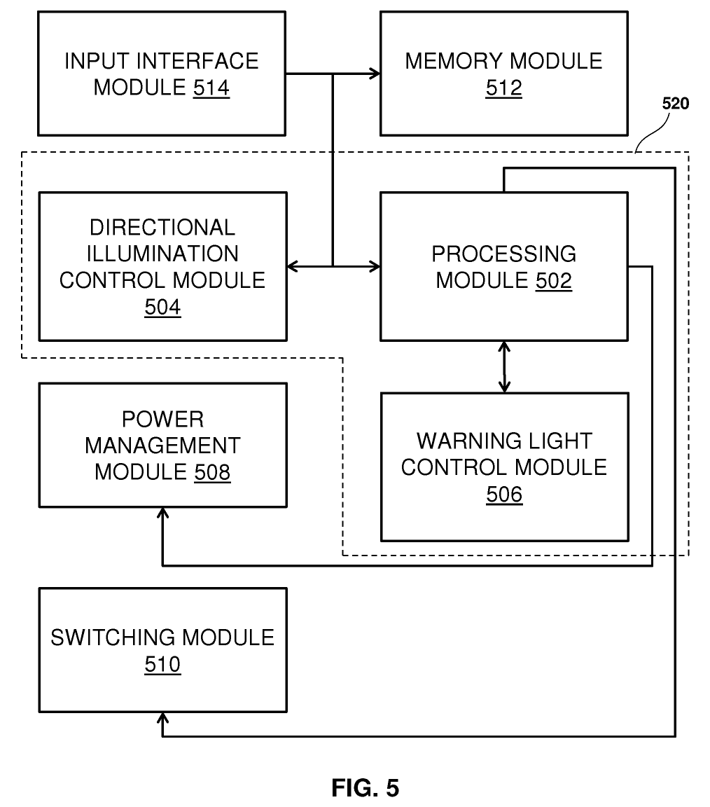

The emergency vehicle lighting system 102 further includes a controller (as shown in FIG. 5). The controller electrically couples to the plurality of directional illumination modules 108 and to the at least one warning light module. The controller controls operation of the plurality of directional illumination modules 108 and the at least one warning light module based on received inputs

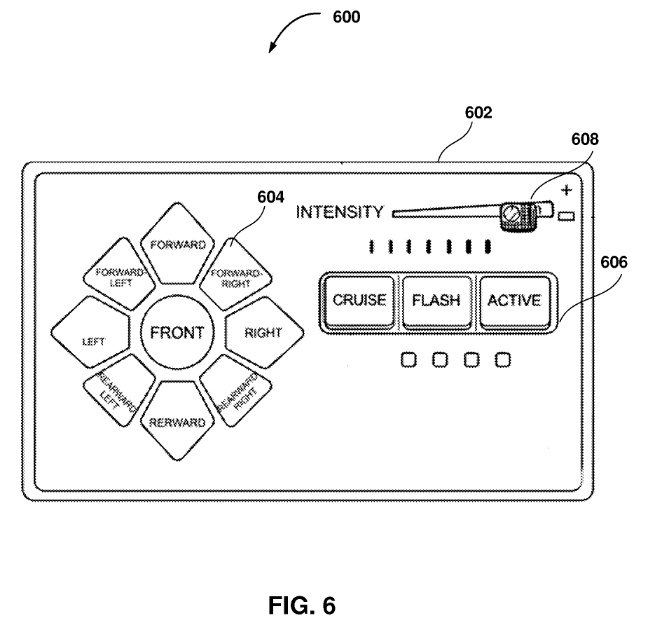

The emergency vehicle lighting system 102 further includes a user interface (as shown in FIG. 6) that communicatively couples to the controller. The user interface receives operator inputs corresponding to selected illumination directions, lighting patterns, or warning light activation. In the illustrated embodiment, the user interface mounts within a passenger compartment of the vehicle 104. In other embodiments, the user interface includes a handheld device, a dashboard mounted control panel, or a remote computing device.

During operation, the controller receives an input from the user interface corresponding to a selected illumination direction. In response to the input, the controller selectively energizes a subset of the plurality of directional illumination modules 108. The subset emits light in the selected illumination direction relative to the vehicle 104. The controller independently energizes the at least one warning light module to emit a warning light output according to a warning pattern, regardless of operation of the subset of the plurality of directional illumination modules 108.

In one example operation, an operator selects a forward illumination direction using the user interface, and the controller energizes a forward facing subset of the plurality of directional illumination modules 108 while simultaneously energizing the at least one warning light module. In another example operation, the controller energizes a diagonal subset of the plurality of directional illumination modules 108 to illuminate a roadside area while maintaining independent warning light operation.

In additional embodiments, the emergency vehicle lighting system 102 integrates into a vehicle light bar or forms a modular lighting assembly attachable to an existing vehicle lighting structure. In further embodiments, the controller receives inputs from a wired vehicle interface or a wireless communication interface in addition to or instead of the user interface. FIG. 1 illustrates one exemplary implementation environment, and other configurations, mounting arrangements, and directional layouts fall within the scope of the invention.

FIG. 2 illustrates a perspective view of the emergency vehicle lighting system 102 showing structural components supported by the housing 106. The emergency vehicle lighting system 102 mounts to the vehicle 104 as described with reference to FIG. 1. The housing 106 defines a structural body that supports and protects internal components of the emergency vehicle lighting system 102. In the illustrated embodiment, the housing 106 has an elongated form factor suitable for mounting to a roof region of the vehicle 104. In other embodiments, the housing 106 has a compact or segmented form factor depending on an intended mounting location or application.

The housing 106 supports the plurality of directional illumination modules 108. Each directional illumination module 108 includes a light source (not shown) and an optical element 202 configured to direct light in a fixed optical output direction relative to the housing 106. The optical element 202 may include a lens, reflector, diffuser, or a combination thereof. Examples of the light source may include a LED die, a LED package, and a laser diode. Each directional illumination module 108 maintains its fixed orientation relative to the housing 106 during operation.

In the embodiment illustrated in FIG. 2, the plurality of directional illumination modules 108 arrange in central area of the housing 106, positioned around or adjacent to a spotlight module 204, to provide illumination coverage in multiple predefined directions relative to the vehicle 104. In other embodiments, the plurality of directional illumination modules 108 arrange in rows, clusters, or zones depending on a desired illumination pattern or coverage area.

The housing 106 also supports the at least one warning light module 206. In an embodiment, the least one warning light module 206 may be positioned around a perimeter region of the housing 106. In another embodiment, some embodiments, the least one warning light module 206 may be positioned within a central region of the housing 106. The at least one warning light module 206 includes a warning light source configured to emit light according to one or more warning patterns. In some embodiments, the at least one warning light module 206 emits light of a selected color associated with emergency vehicle operation.

In an embodiment, the controller may be mounted within an interior region of the housing 106. The controller electrically couples to the plurality of directional illumination modules 108 and to the at least one warning light module 206 through internal electrical connections. The controller selectively energizes individual ones or subsets of the plurality of directional illumination modules 108 and independently energizes the at least one warning light module 206.

In certain embodiments, the housing 106 includes one or more sealing features 208 configured to limit ingress of moisture, dust, or debris. In further embodiments, the housing 106 includes a heat dissipation portion (not shown) configured to dissipate heat generated by the plurality of directional illumination modules 108, the at least one warning light module 206, or the controller.

FIG. 2 illustrates one exemplary structural arrangement of the emergency vehicle lighting system 102. Other arrangements of the plurality of directional illumination modules 108, the at least one warning light module 206, and the controller relative to the housing 106 fall within the scope of the invention.

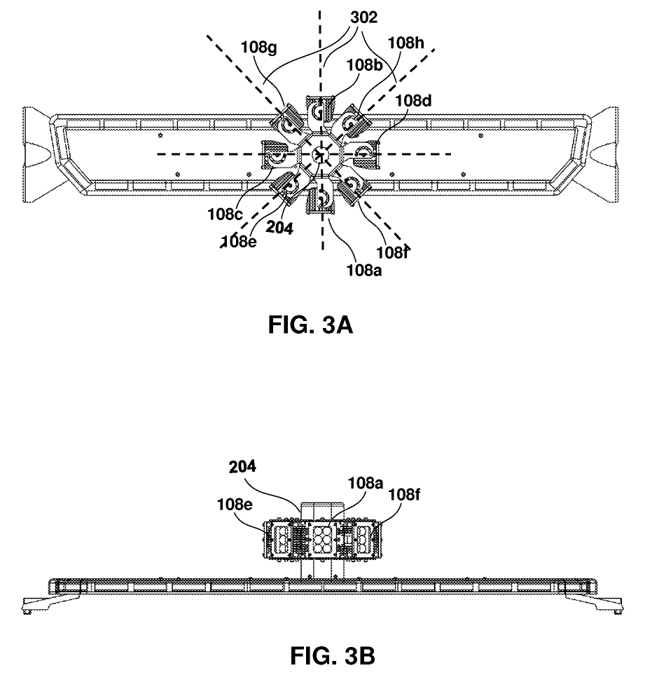

FIG. 3A illustrates a top view of the emergency vehicle lighting system 102 showing fixed optical output directions of the plurality of directional illumination modules 108 relative to the housing 106. As shown in FIG. 3A, the housing 106 defines a reference orientation relative to the vehicle 104. The plurality of directional illumination modules 108 mount to the housing 106 at predetermined locations and orientations. Each directional illumination module 108 directs light along a respective optical axis 302 that remains fixed relative to the housing 106 during operation. In some embodiments, the illustrated subsets 108a through 108h correspond to modules, while in other embodiments the subsets correspond to zones, regions, segments, or logical groupings of emitters within one or more shared lighting structures.

In the illustrated embodiment, the plurality of directional illumination modules 108 include a first subset 108a oriented to emit light in a forward direction relative to the vehicle 104 and a second subset 108b oriented to emit light in a rearward direction relative to the vehicle 104. The plurality of directional illumination modules 108 further include a third subset 108c oriented to emit light in a left lateral direction relative to the vehicle 104 and a fourth subset 108d oriented to emit light in a right lateral direction relative to the vehicle 104.

The plurality of directional illumination modules 108 may also include one or more diagonal subsets 108e, 108f, 108g, and 108h. Each diagonal subset directs light along a diagonal direction relative to the vehicle 104, including forward left as shown in FIG. 3B, forward right as shown in FIG. 3B, rearward left, and rearward right directions. The illustrated arrangement provides directional illumination coverage around the vehicle 104 without requiring mechanical movement of the directional illumination modules 108.

The controller selectively energizes one or more of the subsets 108a through 108h in response to a selected illumination direction. In one example operation, the controller energizes only the first subset 108a to illuminate an area forward of the vehicle 104. In another example operation, the controller energizes the third subset 108c and the fourth subset 108d simultaneously to provide lateral illumination on opposite sides of the vehicle 104.

In additional embodiments, the controller energizes multiple subsets of the plurality of directional illumination modules 108 to provide multi zone illumination. In further embodiments, the controller sequentially energizes different subsets of the plurality of directional illumination modules 108 according to a stored lighting pattern.

FIGS. 3A illustrates one exemplary directional layout of the plurality of directional illumination modules 108. Other numbers, orientations, for example, side view as shown in FIG. 3B, and groupings of directional illumination modules 108 relative to the housing 106 may be used to achieve desired illumination coverage while remaining within the scope of the invention.

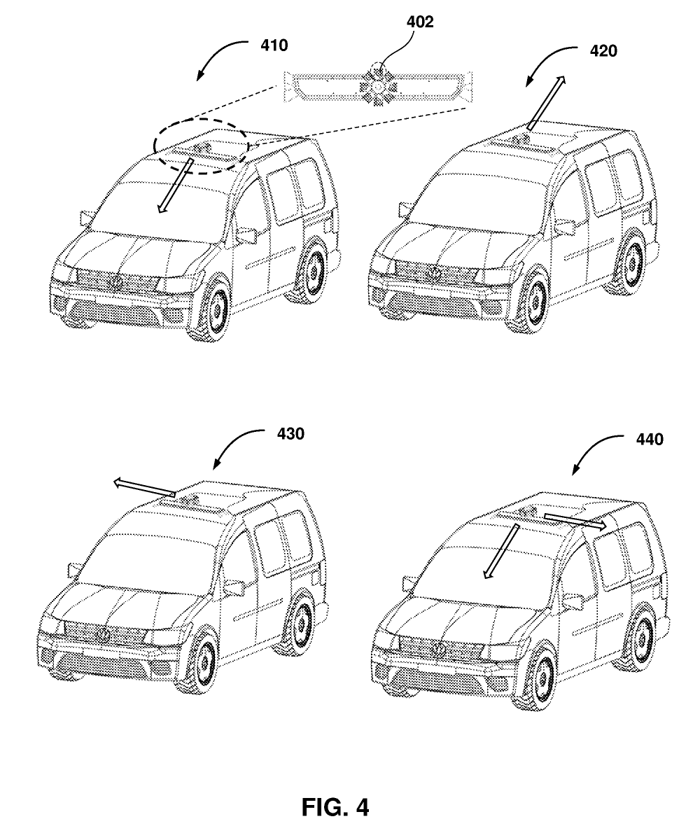

FIG. 4 illustrates an exemplary directional illumination activation scheme of the emergency vehicle lighting system 102. FIG. 4 demonstrates selective energization of subsets of the plurality of directional illumination modules 108 to provide illumination in different directions relative to the vehicle 104. As shown in FIG. 4, the controller selectively energizes a selected subset 402 of the plurality of directional illumination modules 108 based on a selected illumination direction. Each directional illumination module 108 maintains a fixed optical output direction relative to the housing 106, as described with reference to FIGS. 3A-3B.

In a first illustrated activation state 410, the controller energizes a forward facing subset of the plurality of directional illumination modules 108 to illuminate an area forward of the vehicle 104 marked by a forward arrow. The controller de-energizes other subsets of the plurality of directional illumination modules 108 that do not correspond to the selected illumination direction.

In a second illustrated activation state 420, the controller energizes a rearward facing subset of the plurality of directional illumination modules 108 to illuminate an area rearward of the vehicle 104 marked by a backward arrow. The controller maintains independent control of the at least one warning light module 206 during this activation state.

In a third illustrated activation state 430, the controller energizes a diagonal subset of the plurality of directional illumination modules 108 to illuminate an area adjacent to and offset from the vehicle 104 marked by a side arrow. This diagonal illumination supports roadside operations and angled scene coverage.

In a fourth illustrated activation state 440, the controller energizes multiple subsets of the plurality of directional illumination modules 108 simultaneously to provide multi zone illumination marked by multiple arrows. In this activation state, the controller illuminates multiple areas around the vehicle 104 at the same time.

In certain embodiments, the controller executes a selectable officer safety or anti-glare mode. In this mode, the controller selectively energizes one or more directional illumination modules 108, zones, regions, segments, or logical groupings on an approach side of the vehicle 104 at a first intensity level, while energizing one or more directional illumination modules 108, zones, regions, segments, or logical groupings in a forward or oncoming-traffic direction at a reduced second intensity level that is lower than the first intensity level. In some embodiments, the controller also prioritizes illumination of a ground region, step region, or door region adjacent the approach side of the vehicle 104 while maintaining rear illumination or warning illumination at a warning-appropriate intensity.

Throughout each of the activation states 410, 420, 430, and 440, the controller independently energizes or de-energizes the at least one warning light module 206 according to a selected warning pattern. Operation of the plurality of directional illumination modules 108 does not affect operation of the at least one warning light module 206.

In additional embodiments, the controller transitions between different activation states according to a stored lighting pattern or in response to real time inputs received from the user interface as shown in FIG. 6, a wired vehicle interface, or a wireless communication interface.

FIG. 4 illustrates representative activation states for explanatory purposes. Other activation schemes, combinations of subsets, and sequencing arrangements may be implemented while remaining within the scope of the invention.

FIG. 5 illustrates a functional block diagram of the emergency vehicle lighting system 102 showing the controller 520 and associated modules and submodules that support operation of the plurality of directional illumination modules 108 and the at least one warning light module 206. As shown in FIG. 5, the controller 520 includes a processing module 502. The processing module 502 executes control logic for selectively energizing subsets of the plurality of directional illumination modules 108 and for independently controlling the at least one warning light module 206. In one embodiment, the processing module 502 includes a microcontroller. In other embodiments, the processing module 502 includes a processor, a programmable logic device, or a combination thereof.

The controller 520 further includes a memory module 512 communicatively coupled to the processing module 502. The memory module 512 stores program instructions, configuration data, and one or more lighting patterns executable by the processing module 502. In some embodiments, the memory module 512 stores predefined directional illumination patterns and warning light patterns.

An input interface module 514 communicatively couples to the processing module 502. The input interface module 514 receives inputs from the user interface as shown in FIG. 6 corresponding to selected illumination directions, lighting modes, or warning light activation. In additional embodiments, the input interface module 514 receives inputs from a wired vehicle interface or a wireless communication interface.

The wired vehicle interface enables communication between the controller 520 and vehicle systems of the vehicle 104. In one embodiment, the wired vehicle interface includes a vehicle network interface. The wireless communication interface enables communication between the controller 520 and an external device, such as a mobile computing device or a remote control device.

The controller 520 includes a directional illumination control module 504. The directional illumination control module 504 determines which subset 402 of the plurality of directional illumination modules 108 corresponds to a selected illumination direction. The directional illumination control module 504 generates control signals to selectively energize the determined subset 402. In various embodiments, the determined subset 402 may correspond to one or more directional illumination modules 108, zones, regions, segments, or logical groupings.

In certain embodiments, the processing module 502 executes firmware instructions or software logic stored in the memory module 512 to implement directional illumination behavior, safety illumination behavior, anti-glare behavior, warning light behavior, spotlight behavior, and priority or override behavior. Such behavior is achieved through selective energization, dimming, or de-energization of existing directional illumination modules 108, warning light modules 206, spotlight modules 204, or logical groupings thereof, without requiring mechanical movement of the housing 106 or additional movable lighting housings.

The controller 520 further includes a warning light control module 506. The warning light control module 506 controls energization of the at least one warning light module 206 according to a selected warning pattern. The warning light control module 506 operates independently of the directional illumination control module 504.

In certain embodiments, the controller 520 implements priority logic or override logic between directional illumination operation, spotlight operation, warning light operation, and stored lighting patterns. For example, activation of a safety illumination mode, spotlight mode, or selected operator command may cause the processing module 502 to override, suppress, modify, or reprioritize one or more active directional illumination patterns or warning light patterns. In some embodiments, the controller 520 resolves simultaneous inputs according to a stored priority hierarchy.

A power management module 508 electrically couples to the processing module 502 and manages delivery of electrical power to the plurality of directional illumination modules 108, the at least one warning light module 206, and other components of the emergency vehicle lighting system 102. In some embodiments, the power management module 508 includes voltage regulation, current limiting, and fault protection submodules.

The controller 520 outputs control signals to a switching module 510. The switching module 510 includes a plurality of switching elements that selectively connect power from the power management module 508 to individual ones or subsets of the plurality of directional illumination modules 108 and to the at least one warning light module 206. In various embodiments, the switching elements 510 include transistors, relays, or solid state switching devices.

In operation, the processing module 502 receives an input through the input interface module 514. The processing module 502 executes instructions stored in the memory module 512 to determine a selected illumination direction and a warning light operation state. The directional illumination control module 504 and the warning light control module 506 generate corresponding control signals, and the switching module 510 selectively energizes the plurality of directional illumination modules 108 and the at least one warning light module 206 accordingly.

FIG. 5 illustrates one exemplary modular control architecture. Other allocations of functionality among modules and submodules, and other communication arrangements between modules, may be implemented while remaining within the scope of the invention.

FIG. 6 illustrates an exemplary user interface 600 configured to provide control inputs to the emergency vehicle lighting system 102. As shown in FIG. 6, the user interface 600 includes a housing 602 configured for mounting within a passenger compartment of the vehicle 104. In one embodiment, the housing 602 mounts to a dashboard, a center console, or an overhead region of the vehicle 104. In other embodiments, the user interface 600 forms part of a handheld device, a mobile computing device, or a remote control device.

The user interface 600 includes a plurality of directional selection inputs 604. Each directional selection input 604 corresponds to a respective illumination direction supported by the plurality of directional illumination modules 108. In the illustrated embodiment, the plurality of directional selection inputs 604 include forward, rearward, left lateral, right lateral, and diagonal directional inputs. Selection of one of the directional selection inputs 604 causes the user interface 600 to transmit a corresponding directional command to the controller 520.

The user interface 600 further includes one or more warning light control inputs 606. The one or more warning light control inputs 606 enable an operator to activate, deactivate, or modify operation of the at least one warning light module 206 independently of operation of the plurality of directional illumination modules 108.

In certain embodiments, the user interface 600 includes one or more pattern selection inputs. The pattern selection inputs enable selection of predefined lighting patterns stored in the memory module 512 of the controller 520. The predefined lighting patterns may include sequential illumination patterns, multi zone illumination patterns, or combined illumination and warning light patterns.

The user interface 600 may further include an intensity control input 608. The intensity control input 608 enables adjustment of an illumination intensity of the plurality of directional illumination modules 108, the spotlight module 204 when present, or the at least one warning light module 206.

In some embodiments, the user interface 600 includes a visual indicator configured to provide feedback regarding a current operating state of the emergency vehicle lighting system 102. The visual indicator may include one or more light emitting elements, a display screen, or a combination thereof. In some embodiments, the user interface 600 includes one or more override inputs or mode-selection inputs that invoke a priority operating state, including a safety mode, spotlight priority mode, or warning priority mode.

During operation, an operator actuates one or more of the directional selection inputs 604, the warning light control inputs 606, the pattern selection inputs, or the intensity control input 608. The user interface 600 transmits corresponding input signals to the controller 520 through the input interface module 514. The controller 520 processes the input signals and selectively energizes the plurality of directional illumination modules 108 and the at least one warning light module 206 as described with reference to FIGS. 3-5.

FIG. 6 illustrates one exemplary configuration of the user interface 600. Other numbers, arrangements, and types of inputs and indicators may be used to provide control of the emergency vehicle lighting system 102 while remaining within the scope of the invention.

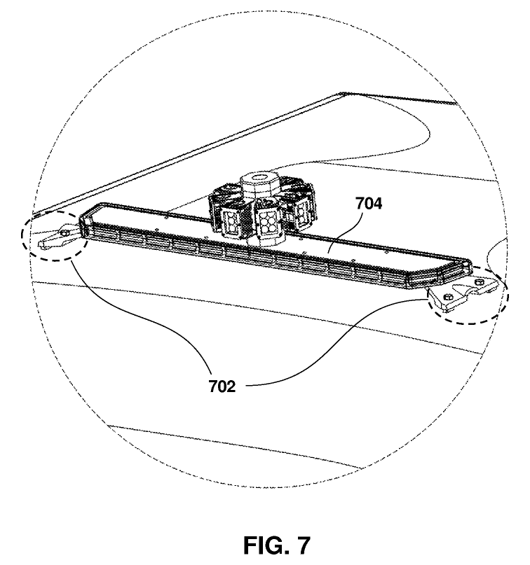

FIG. 7 illustrates a modular lighting assembly 702 configured for attachment to an existing vehicle lighting structure 704, such as the vehicle light bar, to form the emergency vehicle lighting system 102. As shown in FIG. 7, the modular lighting assembly 702 includes a mounting interface configured to mechanically couple the modular lighting assembly 702 to the existing vehicle lighting structure 704. In the illustrated embodiment, the mounting interface includes one or more brackets that secure the modular lighting assembly 702 to the existing vehicle lighting structure 704. In other embodiments, the mounting interface includes clamps, fasteners, rails, or adjustable mounting components that accommodate different sizes and shapes of vehicle lighting structures.

In an embodiment, the modular lighting assembly 702 may include a housing. The housing supports a plurality of directional illumination modules 108 and at least one warning light module 206 as previously described. Each directional illumination module 108 has a fixed optical output direction relative to the housing. The housing positions the plurality of directional illumination modules 108 to provide directional illumination relative to the vehicle 104 when mounted to the existing vehicle lighting structure 704.

The housing further supports the controller 520. The controller 520 electrically couples to the plurality of directional illumination modules 108 and to the at least one warning light module 206. The controller 520 controls operation of the plurality of directional illumination modules 108 and the at least one warning light module 206 independently, as described with reference to FIGS. 3-6.

The modular lighting assembly 702 includes an electrical interface that is configured to connect to a power source of the vehicle 104. In one embodiment, the electrical interface includes a wiring harness configured to connect to a vehicle electrical system. In other embodiments, the electrical interface connects to a power output of the existing vehicle lighting structure 704.

In certain embodiments, the modular lighting assembly 702 operates as a standalone unit that supplements functionality of the existing vehicle lighting structure 704. In other embodiments, the controller 520 coordinates operation of the modular lighting assembly 702 with operation of the existing vehicle lighting structure 704 through the wired vehicle interface or the wireless communication interface.

In one example installation, an operator attaches the modular lighting assembly 702 to an existing light bar without removing or modifying the existing light bar. The operator connects the electrical interface to the vehicle electrical system and configures the controller 520 to respond to inputs from the user interface 600. The modular lighting assembly 702 then provides selective directional illumination and independent warning light operation in combination with the existing vehicle lighting structure 704.

FIG. 7 illustrates one exemplary retrofit embodiment of the emergency vehicle lighting system 102. Other mounting arrangements, electrical connection schemes, and integration configurations may be implemented while remaining within the scope of the invention.

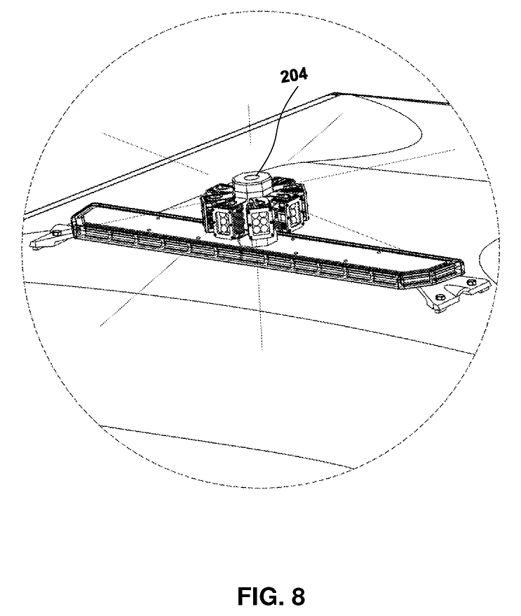

FIG. 8 illustrates an embodiment of the emergency vehicle lighting system 102 that includes the spotlight module 204 supported by the housing 106. As shown in FIG. 8, the spotlight module 204 mounts to the housing 106 of the emergency vehicle lighting system 102. In the illustrated embodiment, the spotlight module 204 positions within or beneath a cover portion of the housing 106. The cover portion protects the spotlight module 204 from environmental exposure while allowing light emission. The cover portion may form a protective cover, an aerodynamic cover, or both. The cover portion protects the spotlight module 204 from environmental exposure, wash conditions, debris, and airflow-related forces while permitting emission of light from the spotlight module 204. In certain embodiments, the cover portion is sealed relative to adjacent portions of the housing 106 and contributes to environmental resistance, aerodynamic performance, and durability of the emergency vehicle lighting system 102.

The spotlight module 204 includes a spotlight light source configured to emit a high intensity beam. The spotlight module 204 directs the high intensity beam in a selected direction relative to the vehicle 104. In some embodiments, the spotlight module 204 directs the high intensity beam in a fixed direction relative to the housing 106. In other embodiments, the spotlight module 204 directs the high intensity beam in one of a plurality of predefined directions relative to the housing 106.

The controller 520 electrically couples to the spotlight module 204. The controller 520 selectively energizes the spotlight module 204 independently of operation of the plurality of directional illumination modules 108 and independently of operation of the at least one warning light module 206.

In one example operation, an operator activates the spotlight module 204 using the user interface 600 while the controller 520 simultaneously energizes a selected subset 402 of the plurality of directional illumination modules 108 and the at least one warning light module 206. In another example operation, the controller 520 energizes the spotlight module 204 while deenergizing the plurality of directional illumination modules 108. In certain embodiments, activation of the spotlight module 204 causes the controller 520 to reduce, suppress, or reconfigure operation of one or more directional illumination modules 108 or warning light modules 206 according to stored priority logic, thereby reducing glare, conserving power, or emphasizing a selected high-intensity beam output.

In certain embodiments, the controller 520 controls an intensity of the spotlight module 204 in response to an intensity control input received through the user interface 600. In further embodiments, the controller 520 operates the spotlight module 204 according to a predefined spotlight pattern stored in the memory module 512.

FIG. 8 illustrates one exemplary spotlight module embodiment. Other configurations, mounting arrangements, and control schemes for the spotlight module 204 may be implemented while remaining within the scope of the invention.

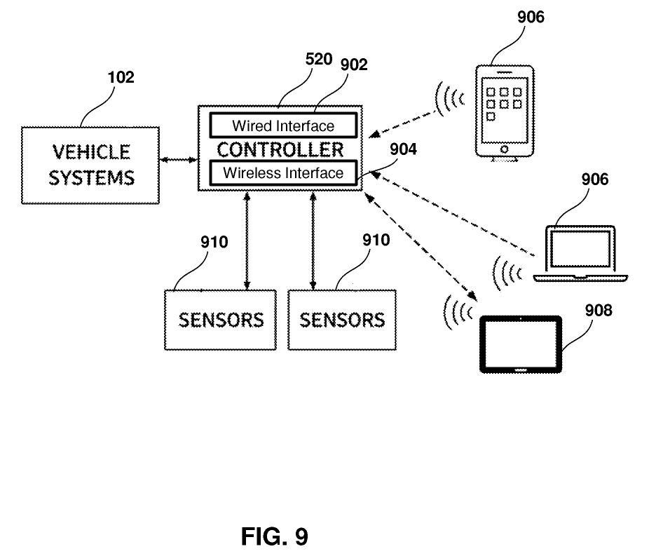

FIG. 9 illustrates an embodiment of the emergency vehicle lighting system 102 in which the controller 520 communicates with one or more external devices and vehicle systems through wired and wireless communication interfaces. In an embodiment, the controller 520 includes the wired vehicle interface 902 and the wireless communication interface 904. The wired vehicle interface 902 enables communication between the controller 520 and one or more vehicle systems of the vehicle 104. In one embodiment, the wired vehicle interface 902 communicates with a vehicle network interface to receive vehicle state information or control signals.

The wireless communication interface 904 enables communication between the controller 520 and the external device 906. In one embodiment, the external device 906 includes a mobile computing device. In other embodiments, the external device 906 includes a remote-control device, a dispatch system, or another computing system.

The controller 520 receives commands, configuration data, or software updates from the external device 906 through the wireless communication interface 904. In certain embodiments, the controller 520 updates lighting patterns, directional illumination logic, or warning light behavior based on data received from the external device 906.

In some embodiments, the controller 520 transmits status information to a remote device 908. The status information may include operating states of the plurality of directional illumination modules 108, the at least one warning light module 206, the spotlight module 204 when present, or fault or diagnostic information.

In further embodiments, the controller 520 receives sensor data from one or more sensors 910. The one or more sensors 910 may include optical sensors, thermal sensors, motion sensors, or proximity sensors mounted to the vehicle 104 or integrated into the emergency vehicle lighting system 102. The controller 520 processes the sensor data to automatically select illumination directions, adjust illumination intensity, or modify lighting patterns.

In further embodiments, the controller 520 determines execution of the safety illumination mode based on predefined logic or based on sensor data, vehicle orientation, roadway side information, geolocation information, door status, operator location, or proximity information. For example, the controller 520 may identify an approach side of the vehicle 104 and automatically prioritize illumination on that side while reducing glare-producing illumination directed toward oncoming traffic.

In one example operation, the controller 520 receives a command from the external device 906 to illuminate a selected area adjacent to the vehicle 104. The controller 520 processes the command and selectively energizes a corresponding subset of the plurality of directional illumination modules 108 while independently operating the at least one warning light module 206. FIG. 9 illustrates one exemplary communication and control embodiment. Other communication protocols, external device types, and sensor arrangements may be implemented while remaining within the scope of the invention.

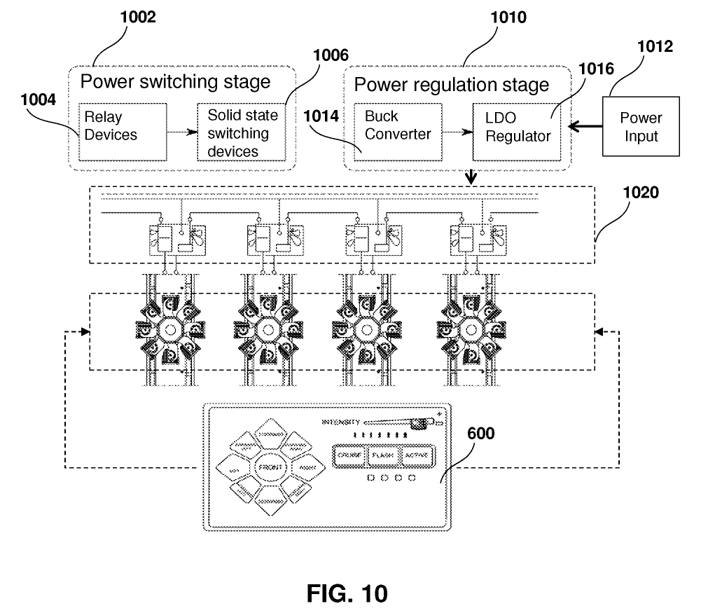

FIG. 10 illustrates a detailed structural embodiment of the emergency vehicle lighting system 102 showing exemplary power switching components, power regulation components, user interface groupings, and environmental protection features that provide fallback structural support for the invention. As shown in FIG. 10, the controller 520 electrically couples to a power switching stage 1002. The power switching stage 1002 includes one or more relay devices 1004 and one or more solid state switching devices 1006. In one embodiment, the solid state switching devices 1006 include metal oxide semiconductor field effect transistors. The controller 520 selectively drives the relay devices 1004 and the solid state switching devices 1006 to independently control power delivery to the plurality of directional illumination modules 108, the at least one warning light module 206, and the spotlight module 204 when present.

The emergency vehicle lighting system 102 further includes a power regulation stage 1010 electrically coupled between a vehicle power input 1012 and the controller 520. The power regulation stage 1010 conditions electrical power received from the vehicle 104. In one embodiment, the power regulation stage 1010 includes a buck converter 1014 configured to step down vehicle supply voltage. In another embodiment, the power regulation stage 1010 includes a low dropout regulator (LDO regulator) 1016 configured to provide a stable supply voltage to the controller 520 and associated logic circuits.

The power regulation stage 1010 may further include protection components 1020, including one or more fuses, transient voltage suppression devices, or reverse polarity protection devices. These components protect the emergency vehicle lighting system 102 from electrical faults and vehicle power fluctuations.

FIG. 10 further illustrates a structured arrangement of user interface inputs within the user interface 600. In the illustrated embodiment, the plurality of directional selection inputs 604 arrange into a directional grouping that spatially corresponds to illumination directions relative to the vehicle 104. The warning light control inputs 606 arrange into a warning control grouping that remains physically separated from the directional grouping to reduce operator error.

The emergency vehicle lighting system 102 further includes environmental protection features associated with the housing 106. In one embodiment, the housing 106 includes one or more sealing members positioned between mating portions of the housing 106. The sealing members include elastomeric materials configured to resist moisture and debris ingress. In other embodiments, the housing 106 includes vibration isolation elements that reduce mechanical stress on internal components during vehicle operation.

FIG. 10 illustrates one exemplary structural implementation that provides explicit hardware distinctions for power switching, power regulation, user interface layout, and environmental protection. Other component selections, arrangements, and material choices may be used while remaining within the scope of the invention.

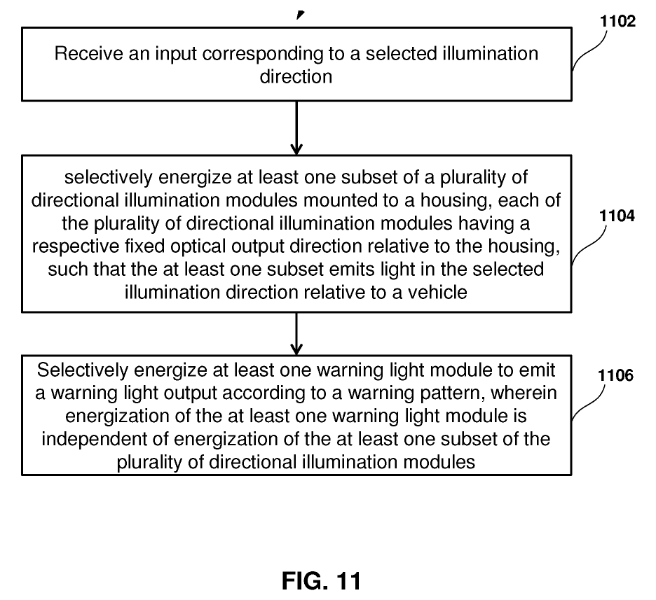

FIG. 11 illustrates an example process flow of a method 1100 of operating the emergency vehicle lighting system 102, in accordance with one embodiment of the present invention. At step 1102, the method includes receiving an input corresponding to a selected illumination direction. In an embodiment, the controller 520 is configured to receive the input corresponding to the selected illumination direction. At step 1104, the method includes selectively energizing at least one subset of a plurality of directional illumination modules 108 mounted to the housing 106, each of the plurality of directional illumination modules 108 having a respective fixed optical output direction relative to the housing 106, such that the at least one subset emits light in the selected illumination direction relative to the vehicle 104. In an embodiment, the controller 520 is configured to selectively energize the at least one subset of a plurality of directional illumination modules 108 mounted to the housing 106, each of the plurality of directional illumination modules 108 having a respective fixed optical output direction relative to the housing 106, such that the at least one subset emits light in the selected illumination direction relative to the vehicle 104.

At step 1106, the method includes selectively energizing the at least one warning light module 206 to emit the warning light output according to a warning pattern, wherein energization of the at least one warning light module 206 is independent of energization of the at least one subset of the plurality of directional illumination modules 108. In an embodiment, the controller 520 is configured to selectively energize the at least one warning light module 206 to emit the warning light output according to a warning pattern, wherein energization of the at least one warning light module 206 is independent of energization of the at least one subset of the plurality of directional illumination modules 108.

The various actions, acts, blocks, steps, or the like in the flow diagram may be performed in the order presented, in a different order, or simultaneously. Further, in some embodiments, some of the actions, acts, blocks, steps, or the like may be omitted, added, modified, skipped, or the like without departing from the scope of the invention.

The invention provides significant advantages by enabling selective directional illumination using fixed orientation directional illumination modules while maintaining independent control of warning light operation. This configuration allows an operator to illuminate only a desired area around a vehicle without energizing unnecessary lights, which reduces glare, conserves electrical power, and improves situational awareness during roadside, emergency, or work related operations. The absence of mechanically movable light components improves reliability, reduces maintenance requirements, and enhances durability in harsh vehicle environments. Independent operation of directional illumination and warning light output further increases operational flexibility, allowing the lighting system to adapt to a wide range of scenarios without increasing operator workload.

The invention also offers substantial structural and installation advantages. The modular architecture supports integration into a vehicle light bar or attachment to an existing vehicle lighting structure without extensive vehicle modification. The use of explicit power regulation and switching components improves electrical stability and fault tolerance across different vehicle power systems. Grouped user interface inputs reduce operator error and enable intuitive control, while sealing and vibration protection features enhance environmental resistance and service life. Together, these advantages provide a robust, scalable, and future ready emergency vehicle lighting system that addresses limitations of existing solutions while remaining adaptable to evolving operational requirements.

Although particular embodiments of the invention have been described in detail for purposes of illustration, various modifications and enhancements may be made without departing from the spirit and scope of the invention.

What is claimed is:

1. An emergency vehicle lighting system, comprising:
a housing configured to be mounted to a vehicle;
a plurality of directional illumination modules supported by the housing, each directional illumination module having a respective light source and a respective optical output oriented in a fixed direction relative to the housing;
at least one warning light module supported by the housing;
a controller electrically coupled to the plurality of directional illumination modules and to the at least one warning light module;
a user interface communicatively coupled to the controller; and
wherein the controller is configured to, in response to an input received via the user interface, selectively energize (i) at least one subset of the plurality of directional illumination modules to provide illumination in a selected direction relative to the vehicle and (ii) the at least one warning light module to provide a warning light output, such that the illumination in the selected direction and the warning light output are independently activatable.

2. The emergency vehicle lighting system of claim 1, wherein the at least one subset comprises at least one of (i) one or more directional illumination modules, (ii) one or more illumination zones, (iii) one or more illumination regions, (iv) one or more illumination segments, or (v) one or more logical groupings of light emitters.

3. The emergency vehicle lighting system of claim 1, wherein the plurality of directional illumination modules comprises at least eight directional illumination modules oriented to provide directional illumination in four cardinal directions and four diagonal directions relative to the housing.

4. The emergency vehicle lighting system of claim 3, wherein the four cardinal directions comprise front, rear, left, and right, and wherein the four diagonal directions comprise front-left, front-right, rear-left, and rear-right.

5. The emergency vehicle lighting system of claim 1, wherein the controller is configured to energize a plurality of the directional illumination modules simultaneously to provide multi-zone illumination.

6. The emergency vehicle lighting system of claim 1, wherein the controller is configured to execute firmware or software logic to implement selective illumination behavior using the plurality of directional illumination modules without requiring mechanical movement of the plurality of directional illumination modules relative to the housing.

7. The emergency vehicle lighting system of claim 1, wherein the controller is configured to energize the plurality of directional illumination modules according to a sequential illumination pattern that changes the selected direction over time.

8. The emergency vehicle lighting system of claim 1, wherein the controller is configured to execute a selectable safety illumination mode in which the controller applies asymmetric illumination behavior relative to the vehicle by prioritizing illumination on an approach side of the vehicle and reducing illumination intensity in at least one forward or oncoming-traffic direction.

9. The emergency vehicle lighting system of claim 1, further comprising a spotlight module supported by the housing, the spotlight module having a spotlight light source with an optical output configured to provide a high-intensity beam, wherein the controller is electrically coupled to the spotlight module and is configured to selectively energize the spotlight module independently of the warning light module.

10. The emergency vehicle lighting system of claim 9, wherein the controller is configured to provide dimming control of the spotlight module.

11. The emergency vehicle lighting system of claim 9, wherein the controller is configured to operate the spotlight module in a direction-selectable mode in which the spotlight module provides the high-intensity beam in at least one selected direction relative to the vehicle.

12. The emergency vehicle lighting system of claim 9, wherein the spotlight module is disposed within or beneath a protective cover supported by the housing, the protective cover being configured to provide environmental protection and aerodynamic performance, wherein the protective cover is sealed relative to adjacent portions of the housing to provide wash resistance and debris resistance, wherein the spotlight module comprises a plurality of fixed optical outputs.

13. The emergency vehicle lighting system of claim 1, wherein the user interface comprises a plurality of direction buttons corresponding to respective directions and at least one pattern button configured to invoke a pre-programmed lighting pattern.

14. A modular lighting assembly configured to be attached to an existing vehicle light bar, the modular lighting assembly comprising:
a mounting interface configured to mechanically couple the modular lighting assembly to the existing vehicle light bar;
a housing supported by the mounting interface;
a plurality of directional illumination modules supported by the housing, each directional illumination module having an optical output oriented in a respective fixed direction relative to the housing;
at least one warning light module supported by the housing;
a controller electrically coupled to the plurality of directional illumination modules and to the at least one warning light module; and
wherein the controller is configured to selectively activate a selected subset of the plurality of directional illumination modules to provide illumination in a selected direction relative to the vehicle while independently activating the at least one warning light module according to a warning pattern.

15. The modular lighting assembly of claim 14, wherein the mounting interface comprises an adjustable mounting bracket configured to accommodate a plurality of different light bar geometries.

16. The modular lighting assembly of claim 14, wherein the plurality of directional illumination modules are arranged to provide 360-degree directional coverage around the vehicle by selective activation of different subsets.

17. The modular lighting assembly of claim 14, further comprising a wiring harness configured to couple to a vehicle power source of 12V to 24V.

18. The modular lighting assembly of claim 14, further comprising at least one fuse disposed in a power path between a vehicle power input and the controller.

19. The modular lighting assembly of claim 14, wherein the controller comprises a microcontroller and a plurality of switching elements including (i) at least one transistor switch for the warning light module and (ii) a plurality of relay switches for respective ones of the plurality of directional illumination modules.

20. The modular lighting assembly of claim 14, wherein the housing is sealed to be water-resistant and vibration-resistant and comprises a heat-dissipating portion formed from metal.

21. A non-transitory computer-readable medium storing instructions that, when executed by a controller of an emergency vehicle lighting system having (i) a plurality of directional illumination modules each oriented in a respective fixed direction relative to a housing and (ii) at least one warning light module, cause the controller to:
receive a command specifying at least one selected direction;
selectively energize a selected subset of the plurality of directional illumination modules based on the command to emit illumination in the at least one selected direction; and
selectively energize the at least one warning light module according to a warning pattern independently of energizing the selected subset.

22. The non-transitory computer-readable medium of claim 21, wherein the instructions further cause the controller to receive the command via at least one communication interface comprising a wired interface or a wireless interface.

23. The non-transitory computer-readable medium of claim 22, wherein the wireless interface comprises at least one of Bluetooth or Wi-Fi, and wherein the wired interface comprises a vehicle network interface including Controller Area Network (CAN bus).

24. The non-transitory computer-readable medium of claim 21, wherein the instructions further cause the controller to perform an over-the-air update to modify at least one lighting pattern stored by the controller.

25. The non-transitory computer-readable medium of claim 21, wherein the emergency vehicle lighting system further comprises at least one sensor, and wherein the instructions further cause the controller to determine the at least one selected direction based on sensor data.

26. The non-transitory computer-readable medium of claim 25, wherein the at least one sensor comprises at least one of a camera, an infrared sensor, a thermal sensor, a radar sensor, an ultrasonic sensor, or a LIDAR sensor.

27. The non-transitory computer-readable medium of claim 25, wherein the instructions further cause the controller to automatically adjust at least one of (i) an intensity of at least one directional illumination module, (ii) an intensity of a spotlight module, or (iii) the warning pattern, based on the sensor data.

28. The non-transitory computer-readable medium of claim 25, wherein the instructions further cause the controller to perform at least one of object detection, motion detection, scene scanning, or target tracking based on the sensor data, and to select the at least one selected direction based on a result of the at least one of object detection, motion detection, scene scanning, or target tracking.
